(19) United States
(12) Patent Application Publication
(10) Pub. No.: US 2025/0381794 A1
(43) Pub. Date: Dec. 18, 2025

(54) AIRFLOW ADJUSTING APPARATUS OF VEHICLE WHEEL

(71) Applicant: SUBARU CORPORATION, Tokyo (JP)

(72) Inventors: Motoki MORIOKA, Tokyo (JP); Hiroshi SHIMAKATA, Tokyo (JP)

(21) Appl. No.: 19/235,310

(22) Filed: Jun. 11, 2025

(30) Foreign Application Priority Data
Jun. 17, 2024 (JP) 2024-097642

(51) Int. Cl. B60B 21/02

(52) U.S. Cl. CPC B60B 21/02; B60B 2900/1216

(57) ABSTRACT

An airflow adjusting apparatus of a wheel of a vehicle includes at least one airflow adjusting plate. The at least one airflow adjusting plate protrudes outward in a vehicle width direction of the vehicle from a coupling member that couples a hub mount and a rim of the wheel. The at least one airflow adjusting plate extends in a direction of a tangent of the rim and includes a wall surface extending inward in a radial direction of the wheel from a downstream side to an upstream side in a rotational direction of the wheel during forward traveling of the vehicle.

### CROSS-REFERENCE TO RELATED APPLICATIONS

The present application claims priority from Japanese Patent Application No. 2024-097642 filed on Jun. 17, 2024, the entire contents of which are hereby incorporated by reference.

### BACKGROUND OF THE INVENTION

### Field of the Invention

The disclosure relates to an airflow adjusting apparatus, of a vehicle wheel, protruding from an outer side in a vehicle width direction of a wheel of an automobile or the like.

### Description of Background Art

Japanese Unexamined Patent Application Publication (JP-A) No. 2019-137216 describes an airflow adjusting apparatus. The entire contents of this publication are hereby incorporated by reference.

### SUMMARY OF THE INVENTION

According to one aspect of the present invention, an airflow adjusting apparatus includes one or more airflow adjusting plates protruding outward in a vehicle width direction of a vehicle from a coupling member that couples a hub mount and a rim of a wheel of the vehicle. The one or more airflow adjusting plates extend in a direction of a tangent of the rim and includes a wall surface extending inward in a radial direction of the wheel from a downstream side to an upstream side in a rotational direction of the wheel during forward traveling of the vehicle.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a left-front side view of a vehicle;

FIG. 2 is a side view of a left-front wheel;

FIG. 3 is a sectional view taken along line III-III in FIG. 2 with the left-front wheel being mounted on a hub;

FIG. 4 is a perspective view of an airflow adjusting plate;

FIG. 5 is a side view of the left-front wheel with the airflow adjusting plate extending in the direction of a tangent of a rim;

FIG. 6 is a left-front side view of the vehicle and illustrates a state in which, in a wheel including the airflow adjusting plate, an airflow jetting outward in the vehicle width direction from the inside of a wheel house is intended to be suppressed;

FIG. 7 is a side view of the left-front wheel and illustrates a modification example of the shape of the airflow adjusting plate;

FIG. 8 is a perspective view illustrating the modification example of the shape of the airflow adjusting plate; and

FIG. 9 is a left-front side view of a vehicle and illustrates a state of an airflow jetting outward in the vehicle width direction from the inside of a wheel house, in a wheel including no airflow adjusting plate.

### DETAILED DESCRIPTION OF THE EMBODIMENTS

Embodiments will now be described with reference to the accompanying drawings, wherein like reference numerals designate corresponding or identical elements throughout the various drawings.

The embodiment of the disclosure is not limited to the counts, shapes, size ratios, and relative positional relationships of the constituent elements that are given in the drawings.

As one example of a vehicle wheel (hereinafter, referred to as a wheel) to which an airflow adjusting apparatus in the present embodiment is applied, the configuration of a left-front wheel provided on a front part of a vehicle body will be described.

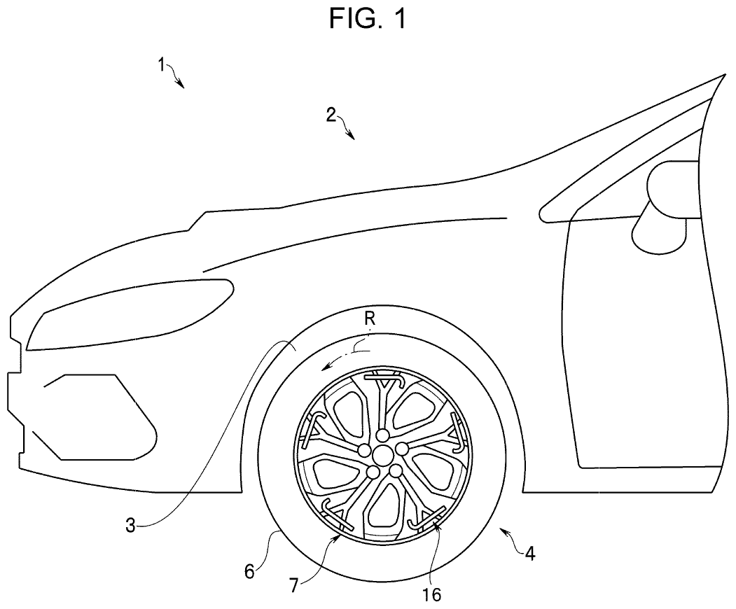

As FIG. 1 illustrates, at a left-front part of a vehicle body 2 of a vehicle 1, a wheel house 3 of an arch-shaped space is formed. A left-front wheel 4 (hereinafter, referred to as a front wheel 4) is accommodated in the space of the wheel house 3.

The front wheel 4 includes a tire 6 and a wheel 7.

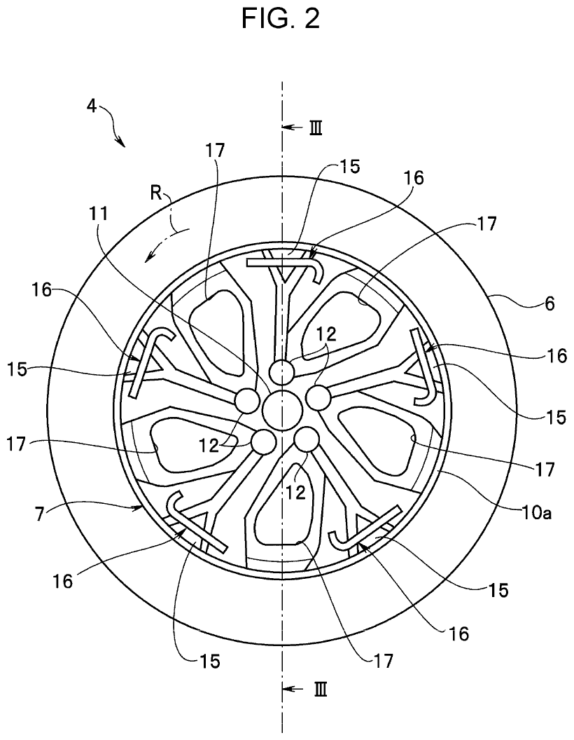

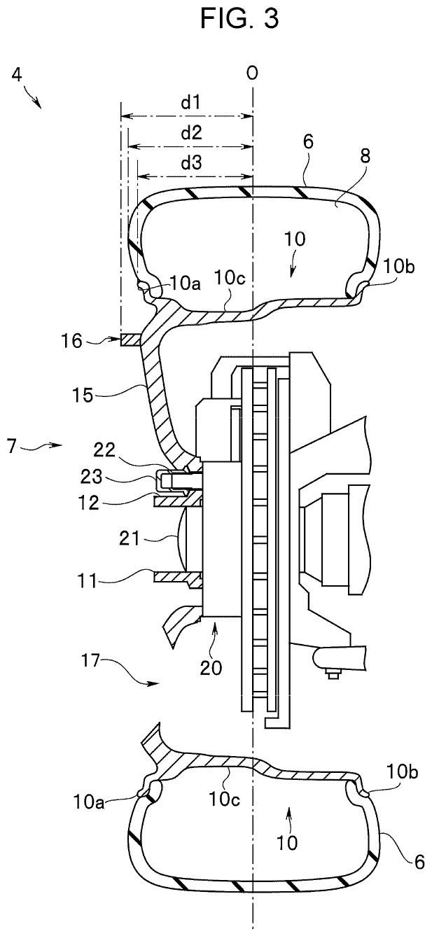

As FIGS. 2 and 3 illustrate, the tire 6 forms the outer peripheral side of the front wheel 4. There is a space 8 on the inner side, in a radial direction, of the tire 6. The tire 6 is formed by, for example, an elastic material such as a rubber material. Thus, during traveling of the vehicle 1, the tire 6 is rotated while in contact with a road surface at a lower end portion.

The wheel 7 includes a rim 10, a hub mount 11, and a spoke 15.

As FIGS. 2 and 3 illustrate, the rim 10 is formed into a ring shape at the outer periphery of the wheel 7. The rim 10 includes an outer flange 10a, an inner flange 10b, and a well 10c.

The outer flange 10a and the inner flange 10b are formed in edge portions of the rim 10 on the outer side and the inner side in the vehicle width direction (protruding end portions in the vehicle width direction), respectively.

The well 10c is formed into a hollow cylindrical shape so as to couple between the outer flange 10a and the inner flange 10b.

The rim 10 configured as described above is fitted to the inside diameter side of the tire 6. Thus, the space 8 of the tire 6 is enclosed. With the enclosed space 8, the rim 10 can hold the tire 6 with the internal pressure of the space 8 being maintained.

The hub mount 11 is a hole part. In a center part of the wheel 7, the hub mount 11 is engaged with a center hub 21 of a hub unit 20 coupled to an axle of the vehicle body 2. Multiple bolt holes 12 (in the present embodiment, five holes) for fastening to bolts 22 of the hub unit 20 are formed around the hub mount 11.

With the bolt holes 12, the hub mount 11 can be engaged with the center hub 21 while being positioned relative to the bolts 22 and can be fastened to the hub unit 20 with a wheel nut 23.

The spoke 15 couples the hub mount 11 and the rim 10. In one embodiment, the spoke 15 may serves as a “coupling member”. Multiple spokes 15 (in the present embodiment, five spokes) extend radially toward the rim 10 (the outer flange 10a) from the hub mount 11. Between every adjacent ones of the spokes 15, an opening hole 17 through which the heat of a brake is dissipated is provided.

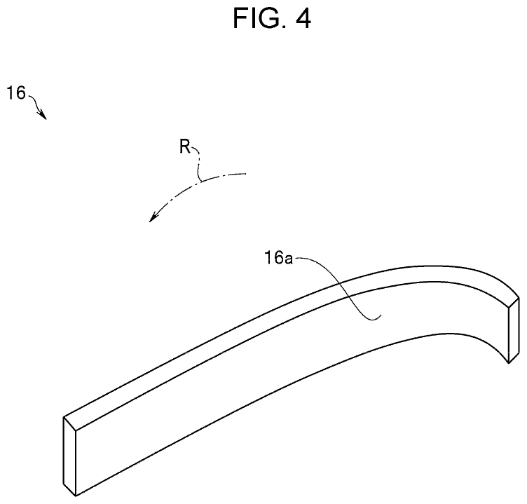

Further, each of the spokes 15 includes, as illustrated in FIGS. 2, 3 and 4, an airflow adjusting plate 16 protruding outward in the vehicle width direction from the spoke 15.

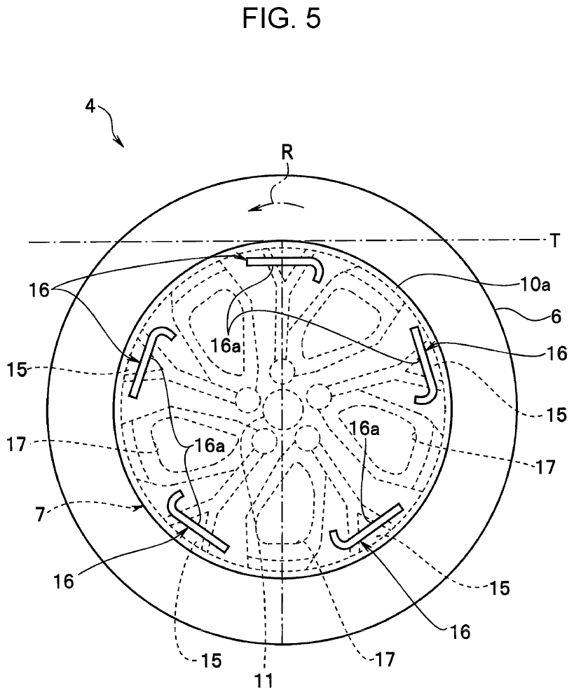

As FIG. 5 illustrates, the airflow adjusting plate 16 extends in the direction of a tangent T of the outer flange 10a of the rim 10. The airflow adjusting plate 16 includes a wall surface 16a.

The wall surface 16a constitutes a surface of the airflow adjusting plate 16 on the inner side in the radial direction of the wheel 7. The wall surface 16a extends inward in the radial direction of the wheel 7 from the downstream side to the upstream side in a rotational direction R of the wheel 7 during forward traveling of the vehicle 1. In addition, the wall surface 16a has a curved shape whose curvature gradually increases as proceeding inward in the radial direction of the wheel 7.

Multiple airflow adjusting plates 16 configured as described above are disposed annularly at regular intervals along the rotational direction R of the wheel 7, for example. In some embodiments, each of the airflow adjusting plates 16 is disposed closer to the outer side in the radial direction of the wheel 7 (closer to the outer flange 10a).

As FIG. 3 illustrates, a distal end of the airflow adjusting plate 16 protruding from the spoke 15 protrudes further outward in the vehicle width direction than a surface of the spoke 15. In some embodiments, such a distal end of the airflow adjusting plate 16 protrudes further outward in the vehicle width direction than a protruding surface of the tire 6 on the outer side in the vehicle width direction and a protruding end portion (the outer flange 10a) of the rim 10 on the outer side in the vehicle width direction.

In one example, a distance d1 from a center line O, in a front-back direction, of the front wheel 4 to the distal end of the airflow adjusting plate 16 is set longer than a distance d2 from the center line O to the protruding surface of the tire 6 and a distance d3 from the center line O to the outer flange 10a. That is, in the present embodiment, the airflow adjusting plate 16 is set to protrude most outward in the vehicle width direction of the front wheel 4.

The wheel 7 configured as described above is shaped as one body by using, for example, a metal material such as an aluminum alloy. The airflow adjusting plate 16 may be produced as a separate body from the wheel 7 and may then be joined to the spoke 15 by a joining method such as welding.

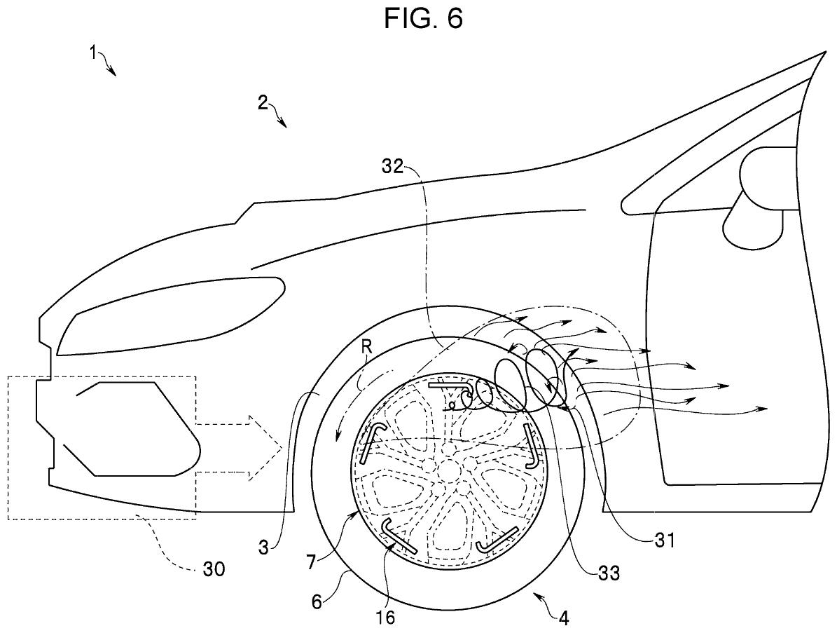

As FIG. 6 illustrates, the airflow adjusting apparatus of the wheel 7 including such an airflow adjusting plate 16 may suppress an airflow 31 jetting outward in the vehicle width direction from the inside of the wheel house 3 when a travel wind 30 flows into the wheel house 3 during traveling of the vehicle 1.

In one example, during traveling of the vehicle 1, the wheel 7 including the airflow adjusting plate 16 rotates while receiving the travel wind 30 flowing from the front of the vehicle 1 along a side surface of the wheel 7. In this case, the airflow adjusting plate 16 can generate, upstream of the wall surface 16a in the rotational direction R, a longitudinal vortex flow 33 toward an upper-rear region 32 of the wheel 7.

The longitudinal vortex flow 33 can adjust the airflow 31 jetting outward in the vehicle width direction from the inside of the wheel house 3 to flow toward the rear of the vehicle.

Thus, the wheel 7 including the airflow adjusting plate 16 may suppress the airflow 31 jetting outward in the vehicle width direction from the inside of the wheel house 3.

Here, in the upper-rear region 32 of the wheel 7, the direction of the travel wind 30 and the rotational direction of the airflow adjusting plate 16 are different. In this case, the relative speed of the rotation of the airflow adjusting plate 16 relative to the travel wind 30 is high. Thus, the airflow adjusting plate 16 may efficiently generate the longitudinal vortex flow 33 in the upper-rear region 32.

On the other hand, in a lower region of the wheel 7 (not illustrated), the direction of the travel wind 30 and the rotational direction of the airflow adjusting plate 16 are the same. In this case, the relative speed of the rotation of the airflow adjusting plate 16 relative to the travel wind 30 is low. Thus, even when the longitudinal vortex flow 33 is generated in the lower region of the wheel 7 (not illustrated), the longitudinal vortex flow 33 is smaller than the longitudinal vortex flow 33 generated in the upper-rear region 32.

According to such an embodiment, the airflow adjusting apparatus of the vehicle wheel 7 includes the airflow adjusting plate 16 protruding outward in the vehicle width direction from the spoke 15 serving as the coupling member that couples the hub mount 11 and the rim 10 of the wheel 7. The airflow adjusting plate 16 extends in the direction of the tangent T of the rim 10 and includes the wall surface 16a extending inward in the radial direction of the wheel 7 from the downstream side to the upstream side in the rotational direction R of the wheel 7 during forward traveling of the vehicle 1. With the above-described constituent elements, even when the strong travel wind 30 flows into the wheel house 3 of the vehicle body 2, the airflow adjusting apparatus of the vehicle wheel 7 may reliably suppress the airflow 31 jetting outward in the vehicle width direction from the inside of the wheel house 3.

That is, the airflow adjusting apparatus of the vehicle wheel 7 includes, for the spoke 15, the airflow adjusting plate 16 protruding outward in the vehicle width direction. In addition, the airflow adjusting plate 16 extends along the tangent T of the rim 10. Moreover, the wall surface 16a of the airflow adjusting plate 16 extends inward in the radial direction of the wheel 7 from the downstream side to the upstream side in the rotational direction R of the wheel 7.

With the action of the wall surface 16a of the airflow adjusting plate 16 configured as described above, the airflow adjusting apparatus of the present embodiment can generate the longitudinal vortex flow 33 toward the upper-rear region 32 of the wheel 7 during traveling of the vehicle 1. The longitudinal vortex flow 33 can adjust the airflow 31 jetting outward in the vehicle width direction from the inside of the wheel house 3 to flow toward the rear of the vehicle. Accordingly, even when the strong travel wind 30 flows into the wheel house 3, the airflow 31 jetting outward in the vehicle width direction from the inside of the wheel house 3 may be reliably suppressed.

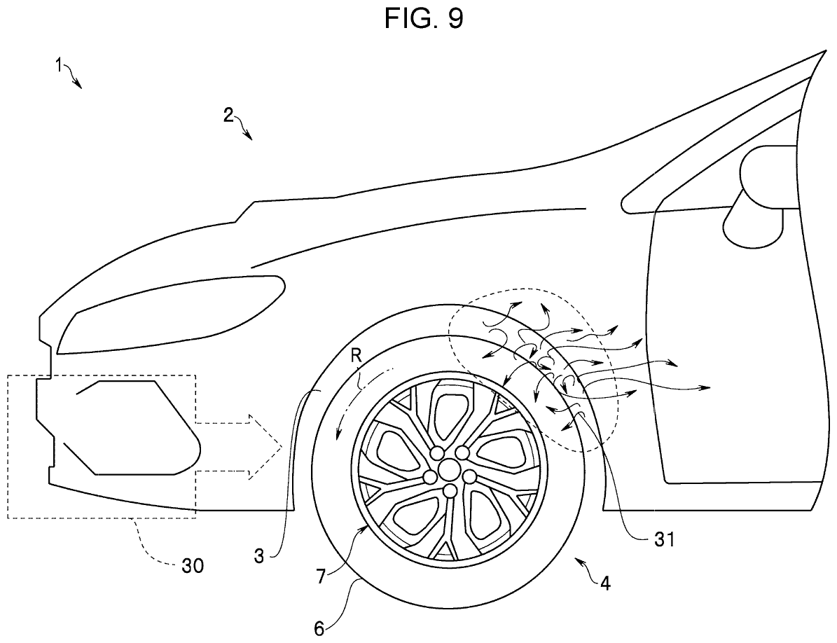

FIG. 9 illustrates, as a comparative example, a state of an airflow 31 brought by a vehicle 1 including a wheel 7 including no airflow adjusting plate 16. As FIG. 9 illustrates, since no longitudinal vortex flow 33 is generated at the wheel 7 including no airflow adjusting plate 16, the airflow 31 jetting outward in the vehicle width direction from the inside of the wheel house 3 jets as it is without being adjusted.

The airflow adjusting plates 16 are disposed annularly at regular intervals along the rotational direction R of the wheel 7, for example. With this configuration, the longitudinal vortex flow 33 can be generated continuously in the upper-rear region 32 of the wheel 7. Thus, even when the strong travel wind 30 flows into the wheel house 3, the airflow 31 jetting outward in the vehicle width direction from the inside of the wheel house 3 may be suppressed more reliably.

The airflow adjusting plate 16 protrudes further outward in the vehicle width direction than the surface of the spoke 15. Thus, the longitudinal vortex flow 33 can be generated by separating the travel wind 30 flowing along the side surface of the wheel 7, from the side surface of the wheel 7. In addition, by being set to protrude most outward in the vehicle width direction of the front wheel 4, the airflow adjusting plate 16 may more reliably generate the longitudinal vortex flow 33 by more appropriately separating the travel wind 30 flowing along the side surface of the wheel 7 from the front of the vehicle 1, from the side surface of the wheel 7.

The wall surface 16a of the airflow adjusting plate 16 has a curved shape whose curvature gradually increases as proceeding inward in the radial direction of the wheel 7. By being set as described above, the airflow adjusting plate 16 may more efficiently generate the longitudinal vortex flow 33 in the upper-rear region 32 of the wheel 7.

The airflow adjusting plate 16 is set to generate the longitudinal vortex flow 33 in an intended region in the upper-rear region 32 in a limited manner. Thus, excessive travel resistance may be suppressed from being generated.

Further, the airflow adjusting plate 16 can adjust the direction, the size, the intensity, and the like of the longitudinal vortex flow 33 by being changed in parameters such as the length, the thickness, the curvature (orientation) of the curved shape of the wall surface 16a, the distance d1 of the distal end of the airflow adjusting plate 16 protruding from the outer side, in the vehicle width direction, of the spoke 15, and the installation number. Thus, the longitudinal vortex flow 33 can be set for various vehicles and wheels.

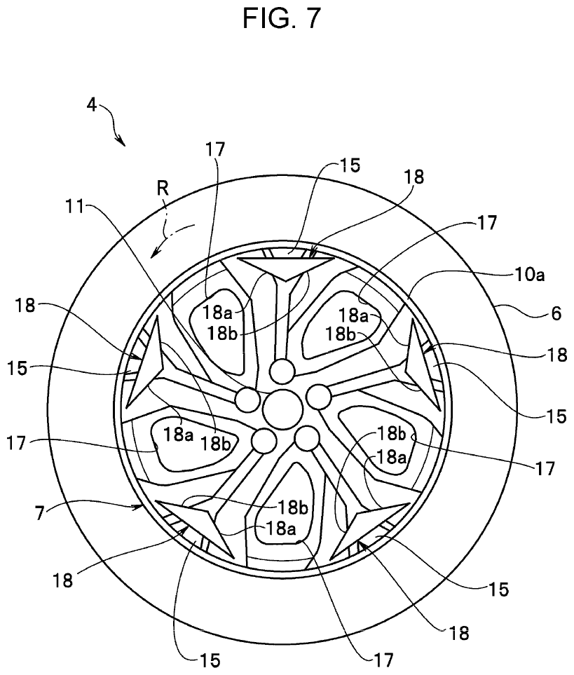

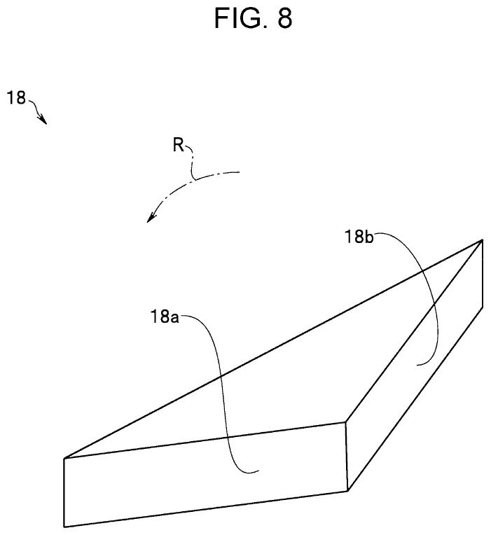

FIGS. 7 and 8 illustrate a modification example of the shape of the airflow adjusting plate 16.

As FIGS. 7 and 8 illustrate, as with the airflow adjusting plate 16, an airflow adjusting plate 18 extends in the direction of the tangent T of the outer flange 10a of the rim 10 (not illustrated). The airflow adjusting plate 18 includes a first wall surface 18a and a second wall surface 18b.

The first wall surface 18a extends inward in the radial direction of the wheel 7 from the downstream side to the upstream side in the rotational direction R of the wheel 7 during forward traveling of the vehicle 1. That is, as with the wall surface 16a of the airflow adjusting plate 16 described above, the first wall surface 18a is used to generate, upstream of the first wall surface 18a in the rotational direction R, the longitudinal vortex flow 33 toward the upper-rear region 32 of the wheel 7.

The second wall surface 18b, as another wall surface of the airflow adjusting plate 18, extends inward in the radial direction of the wheel 7 from the upstream side to the downstream side in the rotational direction R of the wheel 7 during forward traveling of the vehicle 1.

Thus, the airflow adjusting plate 18 is formed into, in plan view, an isosceles triangular shape protruding inward in the radial direction of the wheel 7.

When the airflow adjusting plate 18 configured as described above is applied, the wheels 7 in the left and right wheels can be commonized. Thus, even when the rotation of the tires 6 is performed in maintenance or the like of the vehicle 1, the effect exhibited by the airflow adjusting plate 18 may be maintained. That is, the second wall surface 18b serves as the wall surface that generates the longitudinal vortex flow 33 instead of the first wall surface 18a when the rotational direction R of the wheel 7 is reversed due to the rotation of the tires 6.

The configurations of the airflow adjusting plate 18 in other respects are similar to those of the above-described embodiment (the airflow adjusting plate 16), and description thereof is thus omitted.

Although the example in which the airflow adjusting plate 16, 18 is provided for each spoke 15 is described in the present embodiment, the airflow adjusting plate 16, 18 may be provided on some spokes 15.

In the present embodiment, the coupling member that couples the hub mount 11 and the rim 10 may be, for example, a disk-shaped member without being limited to the above-described spoke 15.

Although description is made for the front wheel 4 in the present embodiment, the present embodiment is also applicable to a rear wheel in a similar manner.

The disclosure described in the above embodiment is not limited to the embodiment, and various modifications can be made at the implementation stage without departing from the spirit of the disclosure. Further, the embodiment described above includes the disclosure at various stages, and various disclosures can be derived by appropriately combining the constituent elements disclosed herein.

In addition, even when some constituent elements are removed from all the constituent elements described in the above embodiment, the configuration from which the constituent elements have been removed can be derived as the disclosure, as long as the problems described herein can be solved and the effects described herein can be achieved. A vehicle body of an automobile or the like during traveling receives air resistance in collision and friction with air. This air resistance can have no small influence on the traveling stability, the fuel efficiency performance, and the like of the vehicle. Thus, reducing the air resistance of the vehicle body during traveling can contribute to improvement in the travel performance.

Examples of the air resistance that may affect the travel performance in existing configurations include air resistance arising from disturbance of the airflow of a travel wind flowing along a side surface of the vehicle body. This air resistance is generated by, while disturbing with the rotation of the wheel, causing the travel wind flowing into a wheel house to jet outward in the vehicle width direction.

Various techniques have been proposed as such an airflow adjusting apparatus, of a wheel, that is intended to suppress the air resistance.

For example, Japanese Unexamined Patent Application Publication (JP-A) No. 2019-137216 describes an airflow adjusting apparatus including a rim guard, and a protrusion provided on the outer side of a spoke in the vehicle width direction. The airflow adjusting apparatus is intended to suppress an airflow, on the outer side in the vehicle width direction relative to a wheel, from being disturbed, by determining a protrusion position of a distal end of the protrusion relative to the position of a distal end of the rim guard protruding outward in the vehicle width direction.

An aspect of the disclosure provides an airflow adjusting apparatus of a wheel of the vehicle. The airflow adjusting apparatus includes at least one airflow adjusting plate. The at least one airflow adjusting plate protrudes outward in a vehicle width direction of the vehicle from a coupling member that couples a hub mount and a rim of the wheel. The at least one airflow adjusting plate extends in a direction of a tangent of the rim and includes a wall surface extending inward in a radial direction of the wheel from a downstream side to an upstream side in a rotational direction of the wheel during forward traveling of the vehicle.

The technique described in JP-A No. 2019-137216 is intended to suppress, in a tire including the rim guard, disturbance of the airflow on the outer side in the vehicle width direction relative to the wheel. Thus, for example, when a strong travel wind during high-speed traveling flows into the wheel house, it is difficult to suppress disturbance due to the airflow jetting outward in the vehicle width direction from the inside of the wheel house. Such a case may have difficulty in reducing the air resistance of the vehicle body, thereby being susceptible to improvement.

It is desirable to provide an airflow adjusting apparatus, of a vehicle wheel, that may reliably suppress an airflow jetting outward in the vehicle width direction from the inside of a wheel house of a vehicle body even when a strong travel wind flows into the wheel house.

Obviously, numerous modifications and variations of the present invention are possible in light of the above teachings. It is therefore to be understood that within the scope of the appended claims, the invention may be practiced otherwise than as specifically described herein.

The invention claimed is:

1. An airflow adjusting apparatus, comprising:
at least one airflow adjusting plate protruding outward in a vehicle width direction of a vehicle from a coupling member that couples a hub mount and a rim of a wheel of the vehicle,
wherein the at least one airflow adjusting plate extends in a direction of a tangent of the rim and comprises a wall surface extending inward in a radial direction of the wheel from a downstream side to an upstream side in a rotational direction of the wheel during forward traveling of the vehicle.

2. The airflow adjusting apparatus according to claim 1, wherein the at least one airflow adjusting plate comprises a plurality of airflow adjusting plates annularly positioned at regular intervals along the rotational direction of the wheel.

3. The airflow adjusting apparatus according to claim 1, wherein the at least one airflow adjusting plate has a distal end having a shape protruding further outward in the vehicle width direction than a surface of the coupling member.

4. The airflow adjusting apparatus according to claim 2, wherein the at least one airflow adjusting plate has a distal end having a shape protruding further outward in the vehicle width direction than a surface of the coupling member.

5. The airflow adjusting apparatus according to claim 1, wherein the at least one airflow adjusting plate has a distal end having a shape protruding further outward in the vehicle width direction than a protruding surface of a tire on an outer side in the vehicle width direction and a protruding end portion of the rim on the outer side in the vehicle width direction.

6. The airflow adjusting apparatus according to claim 2, wherein the at least one airflow adjusting plate has a distal end having a shape protruding further outward in the vehicle width direction than a protruding surface of a tire on an outer side in the vehicle width direction and a protruding end portion of the rim on the outer side in the vehicle width direction.

7. The airflow adjusting apparatus according to claim 1, wherein the wall surface of the at least one airflow adjusting plate has a curved shape having a curvature that gradually increases as proceeding inward in the radial direction of the wheel.

8. The airflow adjusting apparatus according to claim 1, wherein the at least one airflow adjusting plate comprises another wall surface that forms an isosceles triangular shape along with the wall surface in plan view.
